(19) United States
(12) Patent Application Publication
(10) Pub. No.: US 2016/0261193 A1
(43) Pub. Date: Sep. 8, 2016

(54) SWITCHED MODE POWER SUPPLY AND METHOD OF OPERATING A SWITCHED MODE POWER SUPPLY

(71) Applicant: TELEFONAKTIEBOLAGET L M ERICSSON (PUBL), Stockholm (SE)

(72) Inventors: Magnus Karlsson, Oskarshamn (SE); Oscar Persson, Kalmar (SE); Fredrik Wahledow, Färjestaden (SE)

(21) Appl. No.: 14/432,149

(22) PCT Filed: Jun. 18, 2014
(86) PCT No.: PCT/SE2014/050757

§ 371 Date: Mar. 27, 2015

(51) Int. Cl. H02M 3/335; H02M 1/08

(52) U.S. Cl. CPC H02M 3/33507; H02M 1/08

(57) ABSTRACT

A switched mode power supply comprises a switched mode converter and a controller for controlling the switched mode converter, wherein the switched mode converter is provided for converting an input voltage to an output voltage and includes, on a primary side, a primary winding and a controllable switch based circuitry connecting the input voltage over the primary winding; and, on a secondary side, a secondary winding coupled to the primary winding, and a capacitive element connected over the secondary winding, wherein the output voltage is obtained as the voltage over the capacitive element. The primary winding comprises a first winding portion and at least one further winding portion. The switch based circuitry comprises controllable switches capable of switching between a first operation state wherein the input voltage is connected only over the first winding portion and at least a second operation state wherein the input voltage is connected over the first and the at least one further winding portions, thereby enabling switching between two different transformer ratios.

### TECHNICAL FIELD

The technical field relates generally to switched mode power supplies (SMPS:es) and methods of operating switched mode power supplies.

### BACKGROUND

Using a fixed ratio converter intermediate bus converter (IBC) with constant duty cycle causes the output voltage to vary in a large range depending of the input voltage range. This puts restrictions on the input voltage range in order to avoid overvoltage for downstream point of load converters supplied by the IBC. By controlling and switching the transformer ratio, the output voltage range can be decreased.

In most SMPS topologies, the output voltage is directly proportional to the input voltage Vₒ ∝ nDV_{I}, where D is the duty cycle, and n is the transformer ratio if a transformer is used in the SMPS.

Fixed ratio converters or intermediate bus converters, also referred to as unregulated converters, which lack control of the output voltage, run with a fixed maximized duty cycle. This yields maximized power efficiency since the converter transfer energy almost 100% of the time, with the exception of the dead time needed during switching. With this strategy the output voltage varies with the input voltage according to the above equation. The narrow regulation of the voltage is taken care of by a second layer SMPS referred to as point of load regulators: This power architecture is referred to as intermediate bus architecture, see U.S. Pat. No. 7,787,261 B1.

Semi-regulated converters compensate for the varying input voltage (line regulation) at the expense of a varying duty cycle which reduces the power efficiency. The load affects the output voltage and the output voltage decreases with increasing load, also known as drop. Since the output of a SMPS has an LC filter, load transients cause the output voltage to oscillate, where only the inherent parasitic resistances dampen the oscillations.

Quasi-regulated bus converters, which are described in the above cited U.S. Pat. No. 7,787,261 B1, are line regulated in only one portion of the input voltage range, whereas in other portions of the input voltage range, the converters are unregulated using 100% duty cycle. This yields an increased input voltage range without increasing the output voltage range.

Output regulated converters compensate for varying load conditions and input voltage changes by feedback of the output voltage. Voltage feed forward control is often employed in order to reduce output voltage disturbances due to input voltage transients. This type of regulation offers the most stable output voltage at the cost of lower efficiency.

### SUMMARY

The control strategies described in the background have drawbacks in terms of output voltage tolerances, transient responses, and power efficiency. Since many of these properties are dependent upon one another, the optimizing of one causes others to be worse.

It is an aim to provide a switched mode power supply, by which the above drawbacks can be alleviated, or at least mitigated.

A first aspect refers to a switched mode power supply comprising a switched mode converter and a controller for controlling the switched mode converter, wherein the switched mode converter is provided for converting an input voltage to an output voltage and includes, on a primary side, a primary winding and a controllable switch based circuitry connecting the input voltage over the primary winding; and, on a secondary side, a secondary winding coupled to the primary winding, and a capacitive element connected over the secondary winding, wherein the output voltage is obtained as the voltage over the capacitive element. The primary winding comprises a first winding portion and at least one further winding portion; and the switch based circuitry comprises controllable switches capable of switching between a first operation state wherein the input voltage is connected only over the first winding portion and at least a second operation state wherein the input voltage is connected over the first and the at least one further winding portions, thereby enabling switching between at least two different transformer ratios.

The controller may be configured to monitor the output voltage and may be connected to control the controllable switches to switch between the first and the at least second operation states in response to the monitored output voltage. Hereby, the output voltage variation can be reduced.

The duty cycle of the switched mode converter may be constant, e.g. maximized, during operation of the switched mode power supply.

In one embodiment, the controller may configured to control the controllable switches to switch from the second operation state to the first operation state when the monitored output voltage increases above a first threshold voltage and to switch from the first operation state back to the second operation state when the monitored output voltage decreases below the first threshold voltage.

In another embodiment, the controller may be configured to control the controllable switches to switch from the second operation state to the first operation state when the monitored output voltage increases above a first threshold voltage and to switch from the first operation state back to the second operation state when the monitored output voltage decreases below a second threshold voltage, where the first threshold voltage may be higher than the second threshold value to obtain hysteresis control and avoid frequent switching between the operation states at an output voltage which varies around a single threshold voltage.

Additionally, the controllable switches may, in each of the first and second operation states, be capable of switching between a connected state wherein the primary winding may be connected to the input voltage and a disconnected state wherein the input voltage may be disconnected from the primary winding, thereby enabling the duty cycle of the switched mode converter to be altered. The controller may be configured, when the monitored output voltage increases above the first threshold voltage, to control the controllable switches to switch to alter the duty cycle from a nominal duty cycle to a lower duty cycle during a time period, while staying in the second operation state, and, at the end of the time period, to control the controllable switches to switch to simultaneously alter the duty cycle back to the nominal duty cycle and change the operation state from the second operation state to the first operation state.

Further, the controller may be configured, when the monitored output voltage decreases below the second threshold voltage, to control the controllable switches to switch to simultaneously alter the duty cycle from the nominal duty cycle to the lower duty cycle and change the operation state from the first operation state back to the second operation state, and thereafter to control the controllable switches to switch to alter the duty cycle back to the nominal duty cycle during the time period.

The time period may be between about 0.1 and 10 ms, preferably between about 0.2 and 5 ms, more preferably between about 0.5 and 2 ms, and most preferably about 1 ms.

The lower duty cycle times the transformer ratio of the second operation state may, at least approximately, be equal to the nominal duty cycle times the transformer ratio of the first operation state.

The above control scheme is provided for maintaining highest possible power efficiency and minimizing output choke current ripple, while the output voltage variation is reduced.

In a further embodiment, the controller is configured to also monitor the input voltage of the switched mode converter and to control the controllable switches to switch between the first and the at least second operation states also in response to the monitored input voltage to thereby obtain hysteresis control (i.e. the switching to the first operation state has another trigger than the switching to the at least second operation state to avoid frequent switching between the operation states). The above identified thresholds may then be exchanged for thresholds depending on both the monitored output voltage and the monitored input voltage.

This embodiment may be further modified to incorporate the above disclosed varying duty cycle at the transformer ratio switchings.

Thus, in one embodiment, the controller may be configured to control the controllable switches to switch from the second operation state to the first operation when a first condition with respect to the output and input voltages is met and to switch from the first operation state back to the second operation state when a second condition with respect to the output and input voltages is met.

The first condition may comprise that the output voltage is above a first threshold output voltage and the input voltage is above a first threshold input voltage and the second condition may comprise that the output voltage is below a second threshold output voltage and the input voltage is below a second or the first threshold input voltage. The second threshold output voltage may be lower than the first threshold output voltage. The first threshold input voltage may be set so that, in the second operation state, the output voltage rises above the first threshold output voltage simultaneously as the input voltage rises above the first threshold input voltage.

Further, the controllable switches, in each of the first and second operation states, may be capable of switching between a connected state wherein the primary winding is connected to the input voltage and a disconnected state wherein the input voltage is disconnected from the primary winding, thereby enabling the duty cycle of the switched mode converter to be altered.

With such capability, the controller may be configured, when the first condition is met, to control the controllable switches to switch to alter the duty cycle from a nominal duty cycle to a lower duty cycle during a time period, while staying in the second operation state, and, at the end of the time period, to control the controllable switches to switch to simultaneously alter the duty cycle back to the nominal duty cycle and change the operation state from the second operation state to the first operation state. Correspondingly, the controller may be configured, when the second condition is met, to control the controllable switches to switch to simultaneously alter the duty cycle from the nominal duty cycle to the lower duty cycle and change the operation state from the first operation state back to the second operation state, and thereafter to control the controllable switches to switch to alter the duty cycle back to the nominal duty cycle during the time period.

The lower duty cycle times the transformer ratio of the second operation state may be at least approximately equal to the nominal duty cycle times the transformer ratio of the first operation state. The time period may be as disclosed above.

By controlling the number of active primary winding turns the transformer ratio can be changed on the fly.

The controllable switch based circuitry on the primary side may be any of a full bridge, half bridge, or push-pull based circuitry. The secondary side circuitry may be any of a single winding or double center-tapped winding based circuitry. The converter may be provided with synchronous and non-synchronous rectification circuitry.

In one embodiment, the controllable switches may comprise six switches in three legs with two switches in each of the three legs, wherein each of the legs may be connected in parallel with the input voltage, and a point between the switches of a first one of the legs may be connected to one end of the primary winding, a point between the switches of a second one of the legs may be connected to the opposite end of the primary winding, and a point between the switches of a third one of the legs may be connected to a point the primary winding separating the first winding portion and the at least one further winding portion.

In another embodiment, the primary winding may comprise a first winding portion, a second winding portion, and a third winding portion, wherein the switch based circuitry may comprise controllable switches capable of switching between a first operation state wherein the input voltage is connected only over the first winding portion, a second operation state wherein the input voltage is connected only over the first and second winding portions, and a third operation state wherein the input voltage is connected over the first, second, and third winding portions, thereby enabling switching between three different transformer ratios.

The controllable switches may comprise eight switches in four legs with two switches in each of the four legs, wherein each of the legs may be connected in parallel with the input voltage, and a point between the switches of a first one of the legs may be connected to one end of the primary winding, a point between the switches of a second one of the legs may be connected to the opposite end of the primary winding, a point between the switches of a third one of the legs may be connected to a point of the primary winding separating the first and second winding portions, and a point between the switches of a fourth one of the legs may be connected to a point of the primary winding separating the second and third winding portions.

If the controller is configured to control the controllable switches to switch between a connected state wherein the primary winding is connected to the input voltage and a disconnected state wherein the input voltage is disconnected from the primary winding, the controller may be configured to control the controllable switches to switch such that the current direction through the primary winding is altered every time the primary winding is connected to the input voltage.

The switched mode converter may be a DC-DC converter, e.g. a DC-DC voltage down-converter, e.g. configured to operate with input and output voltages in the range of 10-100 V.

A second aspect refers to a base station comprising the switched mode power supply of the first aspect.

A third aspect refers to a method of operating a switched mode converter of the first aspect. According to the method the output voltage is monitored and the controllable switches are switched between the first and the at least second operation states in response to the monitored output voltage. The method of the third aspect may comprise switching the switches in accordance with any of the control schemes, methods, and steps as disclosed above with reference to the first aspect.

Further characteristics and advantages will be evident from the detailed description of embodiments given hereinafter, and the accompanying FIGS. 1-16, which are given by way of illustration only.

### BRIEF DESCRIPTION OF THE DRAWINGS

FIG. 1 illustrates, schematically, in a block diagram an embodiment of a switched mode power supply.

FIG. 2 illustrates, schematically, an embodiment of a base station comprising one or more of the switched mode power supply of FIG. 1.

FIG. 3 illustrates, schematically, in a circuit diagram, an embodiment of a converter, which can be used in the switched mode power supply of FIG. 1.

FIG. 4 illustrates, schematically, in a diagram, a switching pattern for the converter of FIG. 3.

FIG. 5 illustrates, schematically, in a block diagram an embodiment of a driver and control circuit arrangement for the converter of FIG. 3.

FIGS. 6a-d illustrate, schematically, in respective diagrams, the input voltage, the transformer ratio, the output voltage and the choke current of the converter of FIG. 3 during a simulated operation using a first control scheme for the driver and control circuit arrangement of FIG. 5.

FIGS. 7a-d are enlarged portions of the diagrams of FIGS. 6a-d.

FIG. 8 illustrates, schematically, in a diagram, a second control scheme for the driver and control circuit arrangement of FIG. 5.

FIGS. 9a-d illustrate, schematically, in respective diagrams, the input voltage, the transformer ratio, the output voltage and the choke current of the converter of FIG. 3 during a simulated operation using the second control scheme illustrated in FIG. 8.

FIG. 10 illustrates, schematically, a logic circuit to be used in a third control scheme.

FIGS. 11a-d illustrate, schematically, in respective diagrams, the input voltage, the transformer ratio, the output voltage and the choke current of the converter of FIG. 3 during a simulated operation using the third control scheme.

FIG. 12 illustrates, schematically, in a diagram, a fourth control scheme.

FIGS. 13a-e illustrate, schematically, in respective diagrams, the input voltage, the transformer ratio, the output voltage, the choke current, and the duty cycle of the converter of FIG. 3 during a simulated operation using the fourth control scheme.

FIG. 14 illustrates, schematically, in a circuit diagram, an alternative embodiment of a converter, which can be used in the switched mode power supply of FIG. 1.

FIG. 15 illustrates, schematically, in a circuit diagram, a further alternative embodiment of a converter, which can be used in the switched mode power supply of FIG. 1.

FIG. 16 is a schematic flow scheme of an embodiment of a method of operating a converter such as e.g. the converter of FIG. 3.

### DETAILED DESCRIPTION

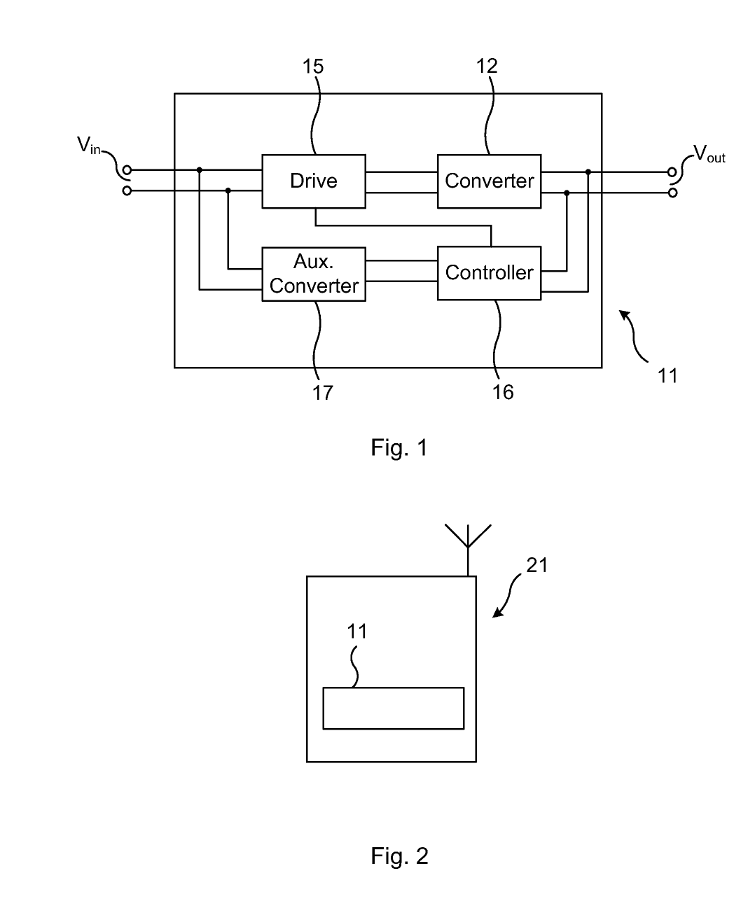

FIG. 1 illustrates, schematically, an embodiment of a switched mode power supply 11 comprising a switched mode converter 12 for converting an input voltage Vᵢₙ to an output voltage Vₒᵤₜ, a drive 15 for driving the converter 12, a controller 16 for controlling the drive 15 and thus the operation of the converter 12, and a housekeeping or auxiliary converter 17 for down converting the input voltage Vᵢₙ to a voltage suitable for the controller 16, such that the controller 16 can be powered by the input voltage Vᵢₙ.

The converter 12 may be an isolated DC-DC converter, typically down-converting the input voltage Vᵢₙ to a suitable output power Vₒᵤₜ. The converter 12 may typically operate with input Vᵢₙ and output Vₒᵤₜ voltages in the range of 10-100 V.

FIG. 2 illustrates, schematically, an embodiment of a base station 21 comprising one or more of the switched mode power supply 11 of FIG. 1.

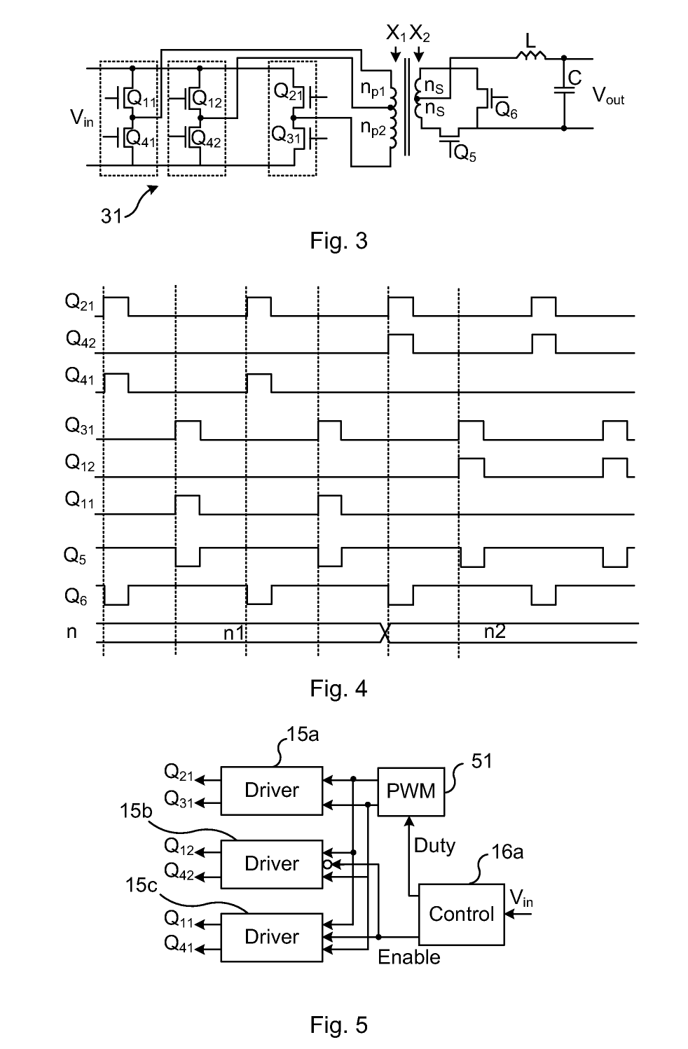

FIG. 3 illustrates, schematically, in a circuit diagram, an embodiment of a converter, which can be used in the switched mode power supply of FIG. 1, wherein a switched primary windings transformer is driven by an extended full-bridge switch circuitry.

The converter comprises, on a primary side, a primary winding X₁ and a controllable switch based circuitry 31connecting the input voltage Vᵢₙ over the primary winding X₁. The primary winding X₁ comprises a first winding portion or number of winding turns nₚ₁ and a second winding portion or number of winding turns nₚ2. The switch based circuitry 31 comprises controllable switches Q₁₁, Q₄₁, Q₁₂, Q₄₂, Q₂₁, Q₃₁ capable of switching between a first operation state wherein the input voltage Vᵢₙ is connected only over the first winding portion nₚ₁ and a second operation state wherein the input voltage is connected over the first nₚ₁ and second nₚ₂ winding portions, thereby enabling switching between two different transformer ratios n₁, n₂ given by:

$$\{ \begin{matrix}{n}_{1} = \frac{{n}_{s}}{{n}_{p 1} + {n}_{p 2}} with Q 11 , Q 41 \\ {n}_{2} = \frac{{n}_{s}}{{n}_{p 1}} with Q 12 , Q 42 \end{matrix}$$

where nₛ is the number of winding turns on the secondary side.

The switches Q₁₁, Q₄₁, Q₁₂, Q₄₂, Q₂₁, Q₃₁ are arranged in three legs with two switches in each of the three legs, wherein each of the legs is connected in parallel with the input voltage Vᵢₙ, and a point between the switches Q₁₁, Q₄₁ of a first one of the legs is connected to one end of the primary winding X_{1,} a point between the switches Q_{21,} Q₃₁ of a second one of the legs is connected to the opposite end of the primary winding X₁, and a point between the switches Q_{12,} Q₄₂ of a third one of the legs is connected to a point the primary winding X₁ separating the first nₚ₁ and second nₚ₁ winding portions.

The converter comprises, on a secondary side, a secondary winding X₂ coupled to the primary winding X₁, an inductive element L connected to one end of the secondary winding X₂ and a capacitive element C connected over the secondary winding X₂, wherein the output voltage is obtained as the voltage over the capacitive element C. The secondary winding X₂ may be a double winding having nₛ number of winding turns in each winding and switches Q₅ and Q₆ are provided for secondary side switching in a customary manner.

The controller 16 of the switched mode power supply 11 is operatively connected to monitor the output voltage Vₒᵤₜ and is configured to control the controllable switches Q₁₁, Q_{41,} Q₁₂, Q_{42,} Q_{21,} Q₃₁ to switch between the first and the second operation states in response to the monitored output voltage Vₒᵤₜ to thereby reduce the output voltage variation.

The controller 16 may be configured to control the controllable switches Q_{11,} Q_{41,} Q_{12,} Q_{42,} Q_{21,} Q₃₁ to switch between a connected state wherein the primary winding X₁ is connected to the input voltage Vᵢₙ and a disconnected state wherein the input voltage Vᵢₙ is disconnected from the primary winding X₁ to thereby obtain a suitable duty cycle.

FIG. 4 illustrates, schematically, in a timing diagram, a switching pattern for the converter of FIG. 3. The gate signals to the respective switches Q_{21,} Q₄₂, Q₄₁, Q_{31,} Q₁₂, Q_{11,} Q_{5,} and Q₆ as well as the active transformer ratio n are illustrated.

Firstly, the leg with switches Q₄₁ and Q₁₁ is active yielding the transformer ratio n₁ in the first operation state, and thereafter the leg with switches Q₄₂ and Q₁₂ is active yielding the transformer ratio n₂ in the second operation state. It shall be noted that the switches Q₄₁ and Q₁₁ in the first operation state and the switches Q₄₂ and Q₁₂ in the second operation state are synchronized with the switches Q₂₁ and Q₃₁ such that the current direction through the primary winding X₁ is alternating in each of the first and second operation states. The switches Q₅ and Q₆ on the secondary side are switched as indicated in a customary manner.

The switching requires an extra set of drivers for driving the switches Q_{21,} Q_{42,} Q₄₁, Q₃₁, Q_{12,} Q_{11,} and a control circuit for selecting the transformer ratio n as compared to a fixed transformer ratio operation using full bridge switching.

FIG. 5 illustrates, schematically, in a block diagram an embodiment of a driver and control circuit arrangement for the converter of FIG. 3 comprising a driver 15a-c for the respective leg of the converter 12, a control circuit 16a for selecting transformer ratio n, and a pulse width modulator (PWM) 51. The drivers 15a-c may be comprised in the drive 15 of the switched mode power supply 11 of FIG. 1 and the control circuit 16a and the pulse width modulator 51 may be comprised in the controller 16 of the switched mode power supply 11 of FIG. 1. The control circuit 16a is configured to select the transformer ratio n depending on the monitored output voltage Vₒᵤₜ and enables the leg Q_{12,} Q₄₂ or the leg Q₁₁, Q₄₁ to be switched.

In a first control scheme for the driver and control circuit arrangement of FIG. 5, the controller 16 is configured to control the controllable switches Q_{11,} Q₄₁, Q₁₂, Q₄₂, Q₂₁, Q₃₁ to switch from the second operation state to the first operation state when the monitored output voltage Vₒᵤₜ increases above a first threshold voltage V_{H} and to switch from the first operation state back to the second operation state when the monitored output voltage Vₒᵤₜ decreases below the first threshold voltage V_{H}.

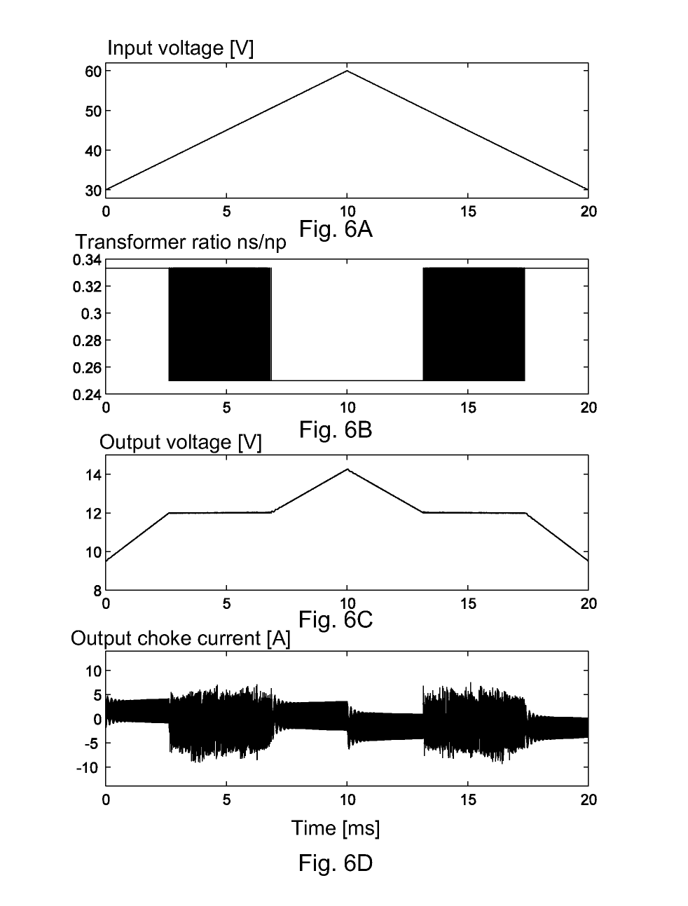

FIGS. 6a-d illustrate, schematically, in respective diagrams, the output voltage, the transformer ratio, the output voltage and the choke current of the converter of FIG. 3 during a simulated operation using the first control scheme.

The simulation was made of a converter with three and four primary winding turns and one secondary winding turn, i.e. the transformer ratios 3:1 and 4:1 respectively. The input voltage was swept in the range [30, 60] V, the first threshold voltage V_{H} was set to 12 V, and the duty cycle was set to Dₙₒₘ=95%. The output choke was 400 nH and the total capacitance was 1.5 mF, which in many applications is a small capacitance.

The simulation shows three different working regions:

(i) the output voltage Vₒᵤₜ is well below 12 V, i.e. well below the first threshold voltage V_{H} was set to 12 V, and the output voltage is increased when the input voltage is increased. The lower ratio transformer ratio 3:1 is used.

(ii) the output voltage Vₒᵤₜ is almost constant at around 12 V, and the transformer ratio is changed continuously between the different ratios using the lower ratio when the output voltage decreases, below 12 V, and uses using higher ratio when the output voltage increases above 12 V.

(iii) the output voltage Vₒᵤₜ is rising above 12 V with a further increased input voltage Vᵢₙ, constantly using the higher ratio 4:1

This means that the output voltage can be held constant at 12V for the input voltage range of 38 to 50V.

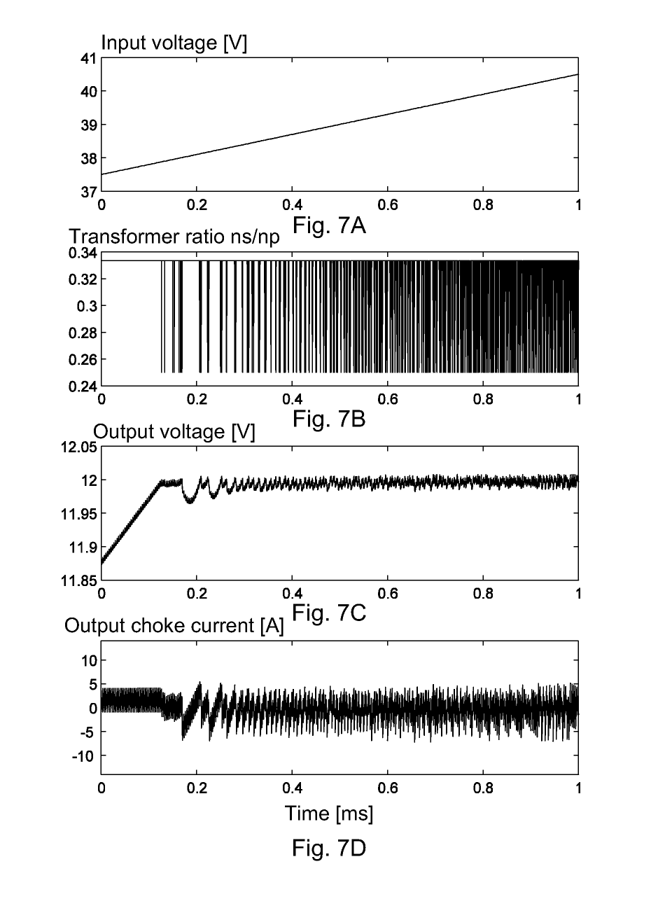

FIGS. 7a-d are enlarged portions of the diagrams of FIGS. 6a-d for an input voltage range of 37 to 41 V, where it is clearly shown how the transformer ratio is changed back and forth keeping the output voltage almost constant at around 12 V.

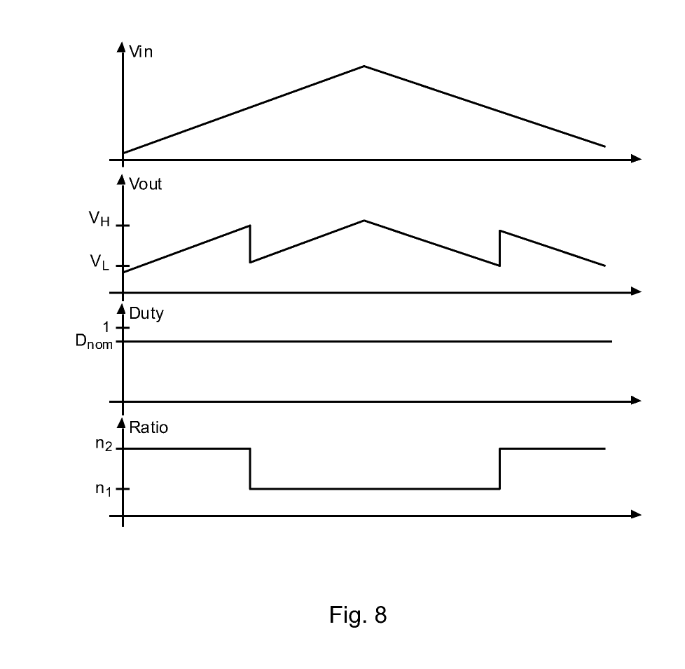

FIG. 8 illustrates, schematically, in a diagram, a second control scheme for the driver and control circuit arrangement of the FIG. 5.

The controller 16 is configured to control the controllable switches Q₁₁, Q₄₁, Q₁₂, Q₄₂, Q₂₁, Q₃₁ to switch from the second operation state to the first operation state when the monitored output voltage Vₒᵤₜ increases above a first threshold voltage V_{H} and to switch from the first operation state back to the second operation state when the monitored output voltage Vₒᵤₜ decreases below a second threshold voltage V_{L}.

The first threshold voltage V_{H} is preferably higher than the second threshold value V_{L} to obtain hysteresis control.

To select the threshold voltages, the first threshold voltage V_{H} may be selected first as it sets the maximum output voltage. In order to obtain a proper hysteresis when switching ratio the following relation should be fulfilled

$${V}_{L} < {V}_{H} \frac{{n}_{{′}_{{p}_{low}}}}{{n}_{{′}_{{p}_{high}}}} - {V}_{m arg}$$

where n´_{Plow}=3 is the lower number of turns at the primary side and n´_{Plow}=4 is the higher number of turns. v_{m arg} is a design margin that has to be used due to the voltage ringing that occurs. Additional low pass filtering can be applied in order to reduce the required design margin. Otherwise the hysteresis is not obtained.

A design example using V_{H}=14.5 V yields

$${V}_{L} < {V}_{H} \frac{{n}_{{′}_{{p}_{low}}}}{{n}_{{′}_{{p}_{high}}}} - {V}_{m arg} = 14.5 * \frac{3}{4} - 1 = 9.87$$

Simulations show that a margin of 1 V is required when not using additional filtering. The margin can be reduced if a filter is applied.

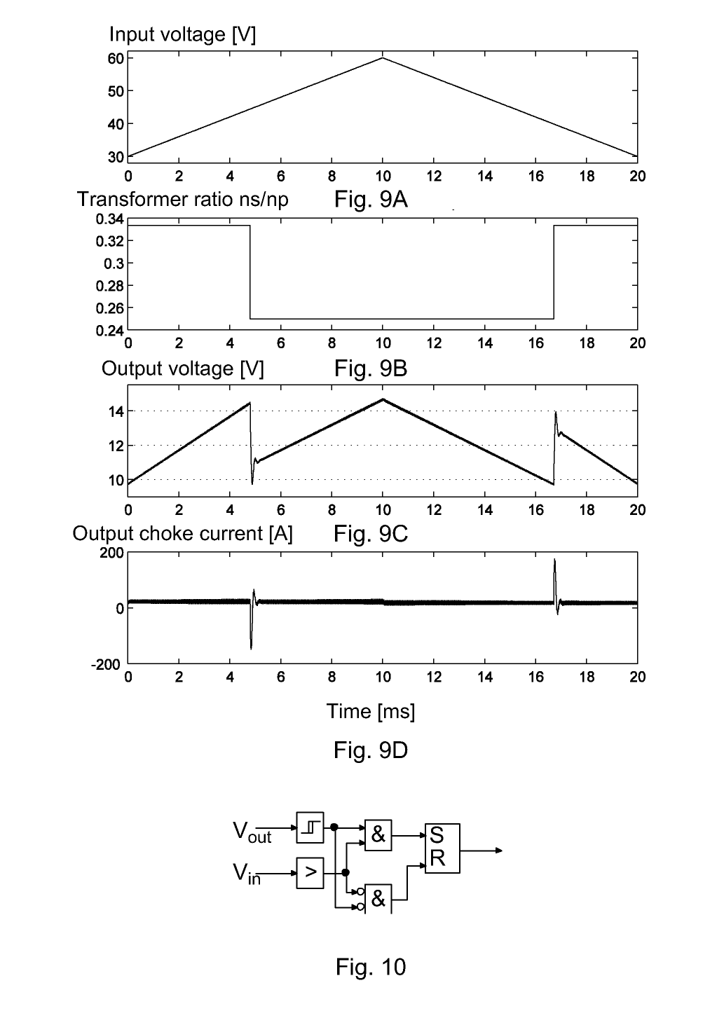

FIGS. 9a-d illustrate, schematically, in respective diagrams, the output voltage, the transformer ratio, the output voltage and the choke current of the converter of FIG. 3 during a simulated operation using the second control scheme illustrated in FIG. 8.

The simulation was made of a converter with three and four primary winding turns and one secondary winding turn, i.e. the transformer ratios 3:1 and 4:1 respectively. The output voltage was swept in the range [30, 60] V, the first threshold voltage V_{H} was set to 14.5 V, the second threshold value V_{L} was set to 9.87 V, and the duty cycle was set to Dₙₒₘ=95%. The output choke was 400 nH and the total capacitance was 1.5mF. The simulation shows that the quick change of transformer ratio causes a ringing in the output filter, shown in both the output voltage and the choke current.

In a third control scheme, the controller of the switched mode power supply is configured to monitor also the input voltage Vᵢₙ of the switched mode converter and configured to control the controllable switches Q₁₁, Q₄₁) Q^{12,} Q_{42,} Q_{21,} Q₃₁ to switch between the first and the second operation states also in response to the monitored input voltage Vᵢₙ. By such design, the above disclosed margin can be omitted.

FIG. 10 illustrates, schematically, a logic circuit to be used in a third control scheme for the driver and control circuit arrangement of FIG. 5. To obtain the transformer ratio switchings, e.g. at V_{H}=14.5 V and V_{L}=10.87 V, and still enable hysteresis control, the input, the threshold level for the input voltage Vᵢₙ for the comparison will then be

Vᵢₙ _{ₜₕᵣₑₛ}>V_{H}n_{Plow}=14.5·3=43.5

The output from the SR latch of the logic circuit of FIG. 10 is equal to 1 when the high number of primary side windings is used and is reset to o when the low number of primary side windings is used.

The SR latch is set to 1, when the output voltage Vₒᵤₜ is above V_{H} and the input voltage Vᵢₙ is above Vᵢₙ_{ₜₕᵣₑₛ}, and the SR latch is reset when the output voltage Vₒᵤₜ is below V_{L} and the input voltage Vᵢₙ is below Vᵢₙ_{ₜₕᵣₑₛ}.

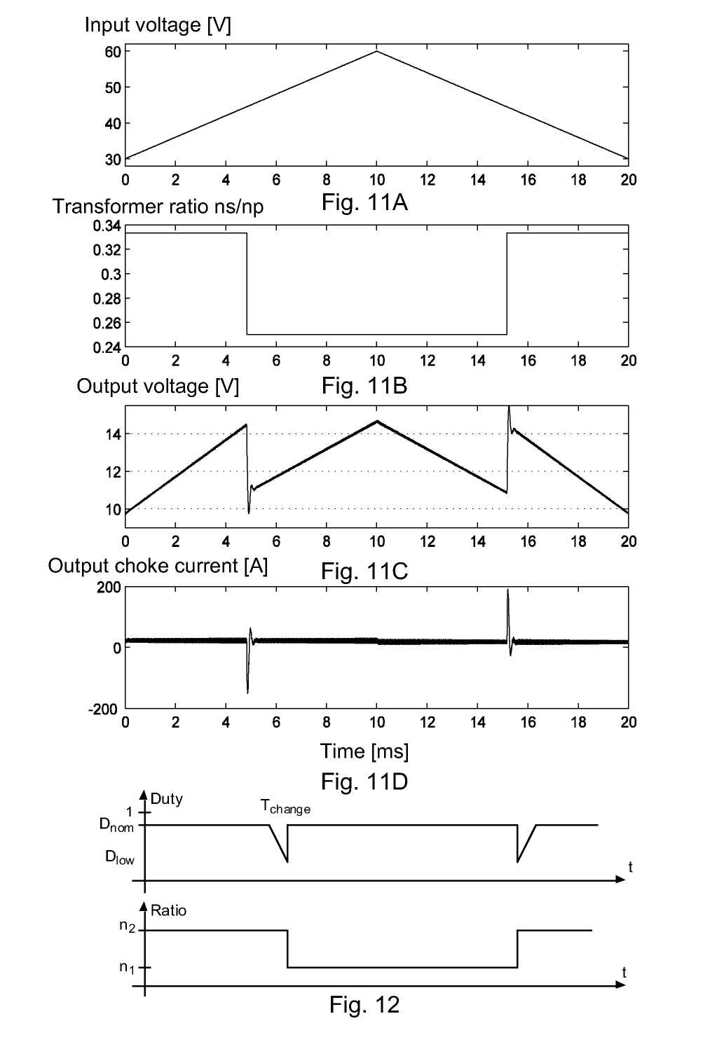

FIGS. 11a-d illustrate, schematically, in respective diagrams, the input voltage, the transformer ratio, the output voltage and the choke current of the converter of FIG. 3 during a simulated operation using the third control scheme. The simulation used the same parameters as those disclosed above. Here it becomes obvious that the thresholds for the hysteresis alone are not enough to obtain an optimum behavior, since the ringing goes beyond the triggering voltages.

The ringing can be reduced with a smooth change of transformer ratio. To this end, FIG. 12 illustrates, schematically, in a diagram, a fourth control scheme for the driver and control circuit arrangement of the FIG. 5.

The controller 16 is configured, when the monitored output voltage Vₒᵤₜ increases above the a threshold voltage V_{II}, to control the controllable switches Q₁₁, Q₄₁, Q₁₂, Q₄₂, Q₂₁, Q₃₁ to switch to alter the duty cycle from a nominal duty cycle Dₙₒₘ to a lower duty cycle D_{low} during a time period T_{change}, while staying in the second operation state, and, at the end of the time period T_{change}, to control the controllable switches Q₁₁, Q_{41,} Q₁₂, Q₄₂, Q₂₁, Q₃₁ to switch to simultaneously alter the duty cycle back to the nominal duty cycle Dₙₒₘ and change the operation state from the second operation state to the first operation state.

The procedure in the opposite direction, when the output voltage Vₒᵤₜ decreases towards a second lower threshold voltage V_{L}, is mirrored.

The controller 16 is thus configured, when the monitored output voltage Vₒᵤₜ decreases below the second threshold voltage V_{L}, to control the controllable switches Q₁₁, Q_{41,} Q_{12,} Q₄₂, Q_{21,} Q₃₁ to switch to simultaneously alter the duty cycle from the nominal duty cycle

Dₙₒₘ to the lower duty cycle D_{low} and change the operation state from the first operation state back to the second operation state, and thereafter to control the controllable switches Q₁₁, Q₄₁, Q₁₂, Q₄₂, Q_{21,} Q₃₁ to switch to alter the duty cycle back to the nominal duty cycle Dₙₒₘ during the time period T_{change}.

The time period T_{change} may be between about 0.1 and 10 ms, preferably between about 0.2 and 5 ms, more preferably between about 0.5 and 2 ms, and most preferably about 1 ms, whereas the change in duty cycle made simultaneously as the operation state is changed, is instantaneous.

To obtain the smooth change of transformer ratio, the lower duty cycle D_{low} times the transformer ratio n₂ of the second operation state should, at least approximately, be equal to the nominal duty cycle Dₙₒₘ times the transformer ratio n₁ of the first operation state:

$${D}_{low} = \frac{{n}_{1}}{{n}_{2}} {D}_{nom} .$$

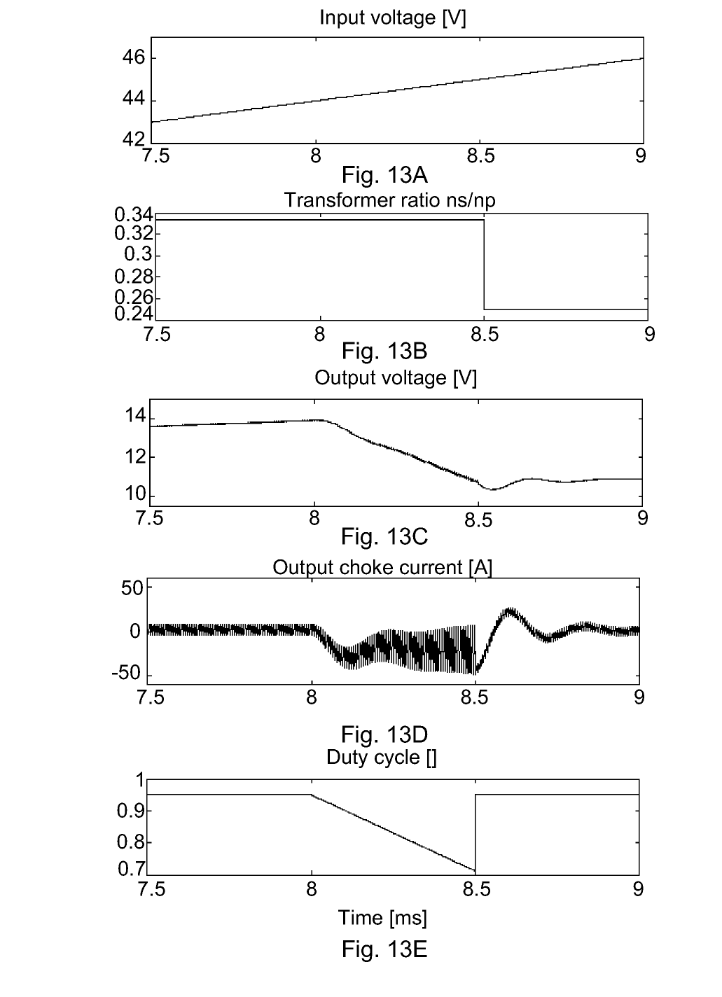

FIGS. 13a-e illustrate, schematically, in respective diagrams, the input voltage, the transformer ratio, the output voltage, the choke current, and the duty cycle of the converter of FIG. 3 during a simulated operation using the fourth control scheme. The simulation used the same parameters as those disclosed above with the addition that the time period T_{change} was set to 0.5 ms, the duty cycle is varying, and the diagrams show only enlarged portions for the first transformer ratio switching.

It can be observed that the output voltage ringing has almost been eliminated, and the current ringing is reduced from almost 200 A down to 50 A peak value. It can also be noted that the current ripple increases when the duty cycle is decreased.

It shall be appreciated that the above disclosed smooth or soft transformer switching with a varying duty cycle can be applied to the third control scheme with hysteresis control based on measurements of both the output voltage Vₒᵤₜ and input voltage Vᵢₙ.

It shall be further appreciated that the concept of switching in and out primary winding portions in response to the monitored output voltage in order to obtain a more stable output voltage can be extended to any number of primary winding portions and thus operation states with different transformer ratios.

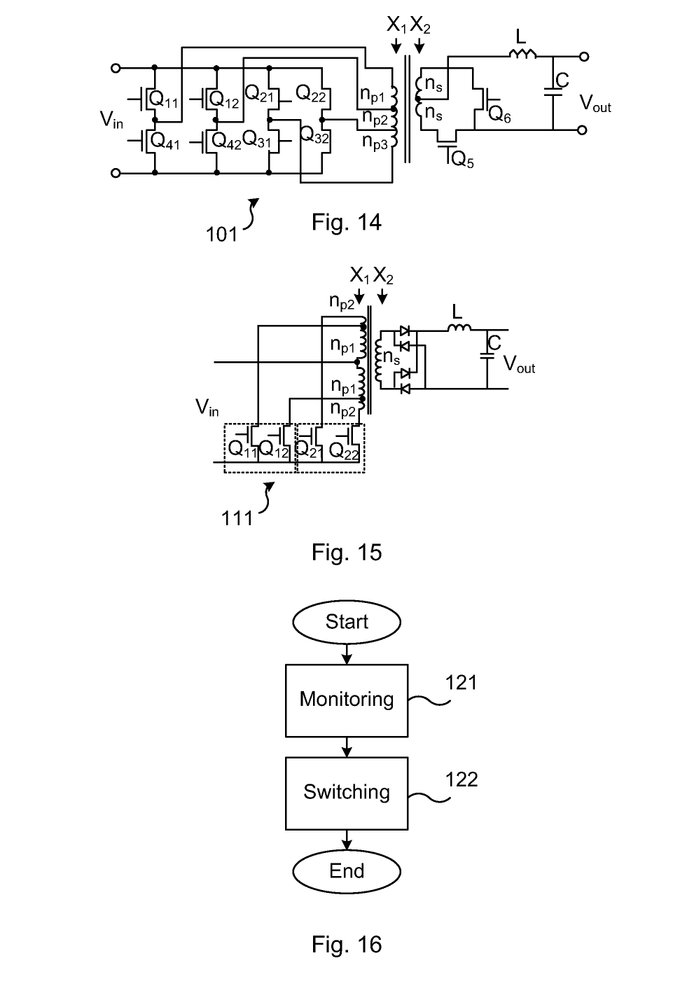

FIG. 14 illustrates, schematically, in a circuit diagram, an alternative embodiment of a converter, which can be used in the switched mode power supply of FIG. 1.

The primary winding X1 comprises a first winding portion nₚ₁, a second winding portion nₚ₂, and a third winding portion nₚ₃, and the switch based circuitry 101 comprises controllable switches Q₁₁, Q₄₁, Q₁₂, Q₄₂, Q₂₁, Q₃₁, Q_{22,} Q₃₂ capable of switching between a first operation state wherein the input voltage Vᵢₙ is connected only over the first winding portion nₚ₁, a second operation state wherein the input voltage Vᵢₙ is connected only over the first nₚ₁ and second nₚ₂ winding portions, and a third operation state wherein the input voltage Vᵢₙ is connected over the first nₚ₁, second n_{p2,} and third nₚ₃ winding portions, thereby enabling switching between three different transformer ratios.

The controllable switches Q₁₁, Q_{41,} Q₁₂, Q₄₂, Q₂₁, Q₃₁, Q₂₂, Q₃₂ are arranged in four legs with two switches in each of the four legs, wherein each of the legs is connected in parallel with the input voltage Vᵢₙ, and a point between the switches Q_{11,} Q₄₁ of a first one of the legs is connected to one end of the primary winding X_{1,} a point between the switches Q₂₁, Q₃₁ of a second one of the legs is connected to the opposite end of the primary winding X₁, a point between the switches Q₁₂, Q₄₂ of a third one of the legs is connected to a point of the primary winding X₁ separating the first nₚ₁ and second nₚ₂ winding portions, and a point between the switches Q_{22,} Q₃₂ of a fourth one of the legs is connected to a point of the primary winding X₁ separating the second nₚ₂ and third nₚ₃ winding portions.

It shall further be appreciated that the concept of switching in and out primary winding portions in response to the output voltage can be applied to a great variety of SMPS topologies beside the full-bridge center-tapped secondary side transformer with synchronous rectification as disclosed above. Such topologies include, but are not limited to, half bridge and push-pull based circuitry on the primary side, and single winding and diode rectification circuitry on the secondary side. The concept can be used in any combination of primary side circuit, secondary side circuit, and type of rectification.

FIG. 15 illustrates, schematically, in a circuit diagram, an example embodiment of a converter, which can be used in the switched mode power supply of FIG. 1, and which is based on a push-pull based circuitry 111 on the primary side and a single winding secondary side circuitry with full-wave diode rectification.

The control of the SMPS employing the can be implemented using either analog or digital electronics. The controller can be arranged on the primary or the secondary side of the converter, with preference to the primary side.

FIG. 16 is a schematic flow scheme of an embodiment a method of operating a converter such as e.g. the converter of FIG. 3. According to the method, the output voltage is, in a step 121, monitored and the controllable switches are, in a step 122, switched between the first and the second operation states in response to the monitored output voltage.

The embodiment of FIG. 16 may be modified to comprise switching of the switches in accordance with any of the control schemes, methods, and/or steps as disclosed above with reference to FIGS. 6-13.

It shall be appreciated by a person skilled in the art that the embodiments disclosed herein are merely example embodiments, and that any details and measures are purely given as examples.

1. A switched mode power supply comprising a switched mode converter and a controller for controlling the switched mode converter, the switched mode converter being provided for converting an input voltage to an output voltage and including:
on a primary side, a primary winding and a controllable switch based circuitry connecting the input voltage over the primary winding; and
on a secondary side, a secondary winding coupled to the primary winding, and a capacitive element connected over the secondary winding, wherein the output voltage is obtained as the voltage over the capacitive element, wherein:
the primary winding comprises a first winding portion and at least one further winding portion;
the switch based circuitry comprises controllable switches capable of switching between a first operation state wherein the input voltage is connected only over the first winding portion and at least a second operation state wherein the input voltage is connected over the first and the at least one further winding portions, thereby enabling switching between two different transformer ratios; and
the controller is (i) configured to monitor the output voltage of the switched mode converter and (ii) operatively connected to the controllable switches to control the controllable switches to switch between the first and the at least second operation states in response to the monitored output voltage.

2. The switched mode power supply of claim 1, wherein the controller is further configured to control the controllable switches to switch from the second operation state to the first operation state when the monitored output voltage increases above a first threshold voltage, and to switch from the first operation state back to the second operation state when the monitored output voltage decreases below the first threshold voltage.

3. The switched mode power supply of claim 1, wherein the controller is further configured to control the controllable switches to switch from the second operation state to the first operation state when the monitored output voltage increases above a first threshold voltage, and to switch from the first operation state back to the second operation state when the monitored output voltage decreases below a second threshold voltage.

4. The switched mode power supply of claim 3, wherein the first threshold voltage is higher than the second threshold value.

5. The switched mode power supply of claim 1, wherein the controller is further configured to monitor the input voltage of the switched mode converter, and to control the controllable switches to switch between the first and the at least second operation states also in response to the monitored input voltage.

6. The switched mode power supply of claim 1, wherein the duty cycle of the switched mode converter is constant.

7. The switched mode power supply of claim 3, wherein the controllable switches, in each of the first and second operation states, are configured to switch between a connected state wherein the primary winding is connected to the input voltage and a disconnected state wherein the input voltage is disconnected from the primary winding, thereby enabling the duty cycle of the switched mode converter to be altered, wherein:
the controller is further configured, when the monitored output voltage increases above the first threshold voltage (V_{H}), to control the controllable switches to switch to alter the duty cycle from a nominal duty cycle to a lower duty cycle during a time period, while staying in the second operation state, and, at the end of the time period, to control the controllable switches to switch to simultaneously alter the duty cycle back to the nominal duty cycle and change the operation state from the second operation state to the first operation state.

8. The switched mode power supply of claim 7, wherein the controller is further configured, when the monitored output voltage decreases below the second threshold voltage, to control the controllable switches to switch to simultaneously alter the duty cycle from the nominal duty cycle to the lower duty cycle and change the operation state from the first operation state back to the second operation state, and thereafter to control the controllable switches to switch to alter the duty cycle back to the nominal duty cycle during the time period.

9. The switched mode power supply of claim 7, wherein the time period is between about 0.1 and 10 ms.

10. The switched mode power supply of claim 7, wherein the lower duty cycle times the transformer ratio of the second operation state is at least approximately equal to the nominal duty cycle times the transformer ratio of the first operation state.

11. The switched mode power supply of claim 1, wherein the controllable switch based circuitry is any of a full bridge, half bridge, or push-pull based circuitry.

12. The switched mode power supply of claim 1, wherein the controllable switches comprise six switches in three legs with two switches in each of the three legs, wherein each of the legs is connected in parallel with the input voltage, and a point between the switches of a first one of the legs is connected to one end of the primary winding, a point between the switches of a second one of the legs is connected to the opposite end of the primary winding, and a point between the switches of a third one of the legs is connected to a point the primary winding separating the first winding portion and the at least one further winding portion.

13. The switched mode power supply of claim 1 wherein
the primary winding comprises a first winding portion, a second winding portion, and a third winding portion; and
the switch based circuitry comprises controllable switches capable of switching between a first operation state wherein the input voltage is connected only over the first winding portion, a second operation state wherein the input voltage is connected only over the first and second winding portions, and a third operation state wherein the input voltage is connected over the first, second, and third winding portions, thereby enabling switching between three different transformer ratios.

14. The switched mode power supply of claim 13, wherein the controllable switches comprise eight switches in four legs with two switches in each of the four legs, wherein each of the legs is connected in parallel with the input voltage, and a point between the switches of a first one of the legs is connected to one end of the primary winding, a point between the switches of a second one of the legs is connected to the opposite end of the primary winding, a point between the switches of a third one of the legs is connected to a point of the primary winding separating the first and second winding portions, and a point between the switches of a fourth one of the legs is connected to a point of the primary winding separating the second and third winding portions.

15. The switched mode power supply of claim 12, wherein the controller is further configured to control the controllable switches to switch between a connected state wherein the primary winding is connected to the input voltage and a disconnected state wherein the input voltage is disconnected from the primary winding.

16. The switched mode power supply of claim 15, wherein the controller is further configured to control the controllable switches to switch such that the current direction through the primary winding is altered every time the primary winding is connected to the input voltage.

17. The switched mode power supply of claim 1, wherein the switched mode converter is a DC-DC converter.

18. The switched mode power supply of claim 1, wherein the switched mode converter is configured to operate with input and output voltages in the range of 10-100 V.

19. A base station comprising the switched mode power supply of claim 1.

20. A method of operating a switched mode converter provided for converting an input voltage to an output voltage and including, on a primary side, a primary winding and a controllable switch based circuitry connecting the input voltage over the primary winding; and, on a secondary side, a secondary winding coupled to the primary winding, and a capacitive element connected over the secondary winding, wherein the output voltage is obtained as the voltage over the capacitive element, wherein the primary winding comprises a first winding portion and at least one further winding portion; and the switch based circuitry comprises controllable switches capable of switching between a first operation state wherein the input voltage is connected only over the first winding portion and at least a second operation state wherein the input voltage is connected over the first and the at least one further winding portions, thereby enabling switching between two different transformer ratios comprising the steps of:
monitoring the output voltage; and
switching the controllable switches between the first and the at least second operation states in response to the monitored output voltage.

21. The method of claim 20, wherein the controllable switches are switched from the second operation state to the first operation state when the monitored output voltage increases above a first threshold voltage, and switched from the first operation state back to the second operation state when the monitored output voltage decreases below the first threshold voltage.

22. The method of claim 20, wherein the controllable switches are switched from the second operation state to the first operation state when the monitored output voltage increases above a first threshold voltage and from the first operation state back to the second operation state when the monitored output voltage decreases below a second threshold voltage.

23. The method of claim 20, further comprising the steps of:
monitoring the input voltage; and
switching the controllable switches between the first and the at least second operation states also in response to the monitored input voltage.

24. The method of claim 21, wherein the duty cycle of the switched mode converter is held constant.

25. The method of claim 22, wherein the controllable switches, in each of the first and second operation states, are capable of switching between a connected state wherein the primary winding is connected to the input voltage and a disconnected state wherein the input voltage is disconnected from the primary winding, thereby enabling the duty cycle of the switched mode converter to be altered, wherein
when the monitored output voltage increases above the first threshold voltage the controllable switches are switched to alter the duty cycle from a nominal duty cycle to a lower duty cycle during a time period, while staying in the second operation state, and, at the end of the time period, the controllable switches are switched to simultaneously alter the duty cycle back to the nominal duty cycle and change the operation state from the second operation state to the first operation state.

26. The method of claim 25 wherein, when the monitored output voltage decreases below the second threshold voltage, the controllable switches are switched to simultaneously alter the duty cycle from the nominal duty cycle to the lower duty cycle and change the operation state from the first operation state back to the second operation state, after which the controllable switches are switched to alter the duty cycle back to the nominal duty cycle during the time period.

27. The method of claim 25, wherein the lower duty cycle times the transformer ratio of the second operation state is at least approximately equal to the nominal duty cycle times the transformer ratio of the first operation state.
